(19) United States
(12) Patent Application Publication
(10) Pub. No.: US 2014/0311872 A1
(43) Pub. Date: Oct. 23, 2014

(54) CABLE CHAIN WITH MOLDED FLIGHTS FOR TUBULAR DRAG CONVEYOR

(71) Applicant: SPIROFLOW SYSTEMS, INC., Monroe, NC (US)

(72) Inventor: Michel John Podevyn, Grindleton Nr Clitheroe (GB)

(73) Assignee: SPIROFLOW SYSTEMS, INC., Monroe, NC (US)

(21) Appl. No.: 13/865,348

(22) Filed: Apr. 18, 2013

(51) Int. Cl. B65G 19/20

(52) U.S. Cl. CPC B65G 19/20
USPC 198/728

(57) ABSTRACT

A chain link for a tubular conveyor, including an elongate endless loop having first and second opposed, spaced-apart link segments that each include a respective opposing, inwardly extending anchoring recess on an outer surface adapted to receive and retain a conveyor chain flight on the chain link.

### TECHNICAL FIELD AND BACKGROUND OF THE INVENTION

This invention relates to tubular drag conveyors, and more specifically to tubular drag conveyors of the type that utilize an endless chain formed of interconnected chain links to pull spaced-apart flights located on the chain links through the tube of the conveyor. Pockets formed between adjacent flights are charged with divided, flowable bulk materials, for example, powdered, granulated or small particle materials, and the movement of the flights through the conveyor transfers the materials from one or more in-feed points to one or more discharge points. The flights are formed of discs having a shape conforming to the interior shape of the conveyor tube in which they are positioned and seal against the interior walls of the conveyor.

This type of conveyor has been used for many years, and is particularly useful when it is necessary to change direction, move the materials around corners, or up or down from one level to another in a three-dimensional environment.

Attachment of the flights to a cable by molding is known. However, heretofore it has not been thought feasible to mold the flights to a cable chain link conveyor because of the smooth, regular shape of the interlocked oval chain links. Instead, chain components connected by link pins are used, and the flights are typically connected to chain links by pins that pass through an enlarged hub on the flight and extend through the link to achieve a physical lock between the two elements. Then, the pins are sealed by compressing an elastomer washer around the pins and between the links to seal out abrasive and corrosive materials from the pin bearing surfaces. The practice limits the size of the chain links to relatively large links that have sufficient thickness within which to form holes of a size large enough to receive a pin sufficiently strong to carry the load of the flight on the link. As is clear from the above, a number of separate parts and assembly steps are necessary to accomplish the assembly of a chain conveyor with attached flights. This type of chain is relatively expensive.

In contrast, the ability to efficiently and inexpensively mold flights onto a relatively simple cable chain link formed of interconnected oval links would increase the utility of cable chain link conveyors.

### SUMMARY OF THE INVENTION

It is therefore an object of the invention to provide a cable chain conveyor for a tubular drag conveyor that permits a flight to be molded onto predetermined links of the chain.

It is another object of the invention to provide a cable chain conveyor for a tubular drag conveyor that avoids the need of separate attachment parts, such as pins and washers, by which the flights are attached to the chain links.

It is another object of the invention to provide a cable chain conveyor for a tubular drag conveyor that avoids multiple assembly steps to attach a flight to a chain link.

It is another object of the invention to provide a cable chain conveyor for a tubular drag conveyor that permits a flight to be molded onto a chain link of a conveyor chain.

These and other objects and advantages of the present invention are achieved by providing a cable chain link for a tubular conveyor, that includes an elongate endless loop having first and second opposed, spaced-apart link segments that each include a respective opposing, inwardly extending anchoring recess on an outer surface adapted to receive and retain a conveyor chain flight on the chain link.

In accordance with another embodiment of the invention, the recess defines an annular shape in cross-section.

In accordance with another embodiment of the invention, a flight is received and retained on the chain link by an interference fit with the recess on the respective outer surface of the link segments.

In accordance with another embodiment of the invention, the flight is molded onto the chain link.

In accordance with another embodiment of the invention, the flight is selected from the group consisting of plastic, resin or metal.

In accordance with another embodiment of the invention, the flight is molded onto the chain link and comprises ultra high molecular weight polyethylene.

In accordance with another embodiment of the invention, the flight includes a centrally-positioned hub having a predetermined thickness and an integrally-formed annular distal flight portion extending radially-outwardly from the hub and having a thickness that is less than the thickness of the hub.

In accordance with another embodiment of the invention, a conveyor chain for a tubular conveyor chain is provided and includes a multiplicity of interconnected chain links forming an endless loop for being passed through a conveyor tube. Predetermined ones of the chain links form an elongate endless loop having first and second opposed, spaced-apart link segments that each include a respective opposing, inwardly extending anchoring recess on their respective outer surface. A flight is carried on the predetermined ones of the cable chain links and retained on the chain links by an interference fit with the recess on the respective outer surface of the link segments and defining product-conveying pockets between adjacent ones of the flights.

In accordance with another embodiment of the invention, the predetermined ones of the chain links carrying the flights are spaced-apart from each other by chain links not carrying flights, the product carrying pockets being defined by the space between the chain links carrying the flights.

In accordance with another embodiment of the invention, a tubular drag conveyor is provided, and includes an endless loop conveyor tube having a predetermined cross-sectional shape, with a multiplicity of interconnected chain links positioned coextensively in an endless loop in the conveyor tube, predetermined ones of the chain links comprising an elongate endless loop having first and second opposed, spaced-apart link segments that each include a respective opposing, inwardly extending anchoring recess on an respective outer surface. A flight is carried on the predetermined ones of the chain links and retained on the chain link by an interference fit with the recess on the respective outer surface of the link segments and defining product-conveying pockets between adjacent ones of the flights. A motor assembly is connected to the endless loop of chain links for driving the chain links and the flights carried thereon through the conveyor tube.

In accordance with another embodiment of the invention, the predetermined ones of the chain links carrying the flights are spaced-apart from each other by chain links not carrying flights, the product carrying pockets being defined by the space between the chain links carrying the flights.

### BRIEF DESCRIPTION OF THE DRAWINGS

The invention will be more fully appreciated and illustrated when considered in connection with the following drawings, in which:

FIG. 1 is a perspective view of a tubular drag conveyor of a type with which the cable chain of the present invention is suitable for use;

FIG. 2 is a fragmentary perspective view, with parts broken away for clarity, showing a cable chain link conveyor according to one preferred embodiment of the invention;

FIG. 3 is a plan view of a cable chain link according to one embodiment of the invention;

FIG. 4 is a plan view of a cable chain link according to one embodiment of the invention, with a flight, shown in phantom, molded to the chain link;

FIG. 5 is a plan view of a cable chain link according to one embodiment of the invention with a flight, with first and second opposed, spaced-apart link segments that each include respective opposing, inwardly extending anchoring recesses shown in phantom on an outer surface adapted to receive and retain a conveyor chain flight on the chain link; and

FIG. 6 is a plan view of a cable chain link according to one embodiment of the invention, with a flight molded to the cable chain link.

### DETAILED DESCRIPTION OF THE PREFERRED EMBODIMENT AND BEST MODE

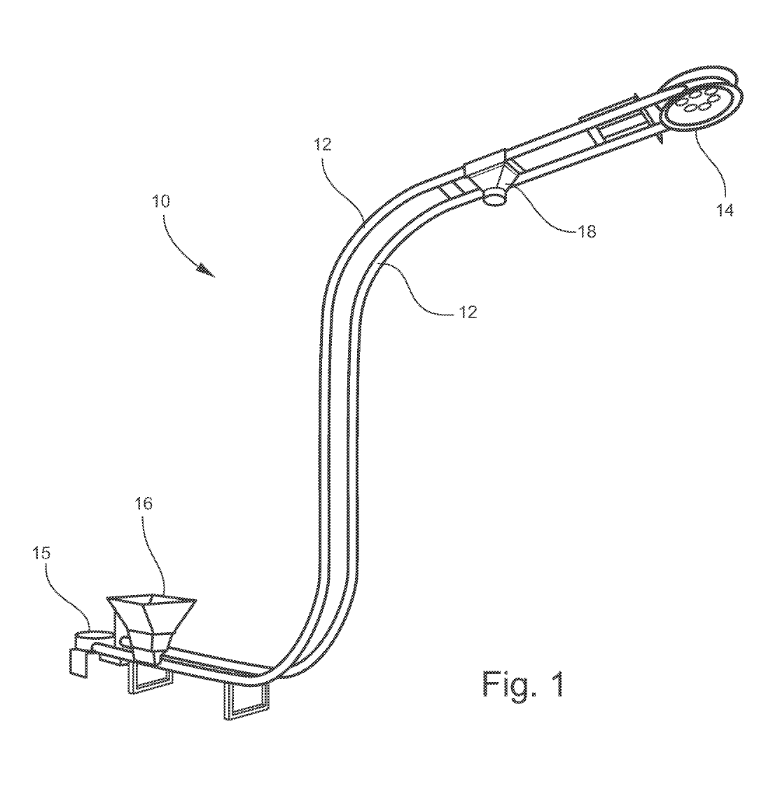

Referring now to the drawings, a tubular drag conveyor is shown at broad reference numeral 10 of FIG. 1, and includes an endless loop tubular conveyor 12. The term “tubular drag conveyor” is one of a number of terms, such as “drag conveyor”, “drag link conveyor”, and “tubular chain drag conveyor” that all refer to the same general type of conveying equipment, and the term “tubular drag conveyor” is used in this application in the broad sense to mean conveyors of this general type that use an endless loop chain moving through an enclosed tube to convey flowable material. While a conveyor that is circular in cross-section is disclosed for purpose of illustration, conveyers that are square, rectangular or other non-annular shapes may be used with the invention disclosed in the application, and are within the scope of the invention.

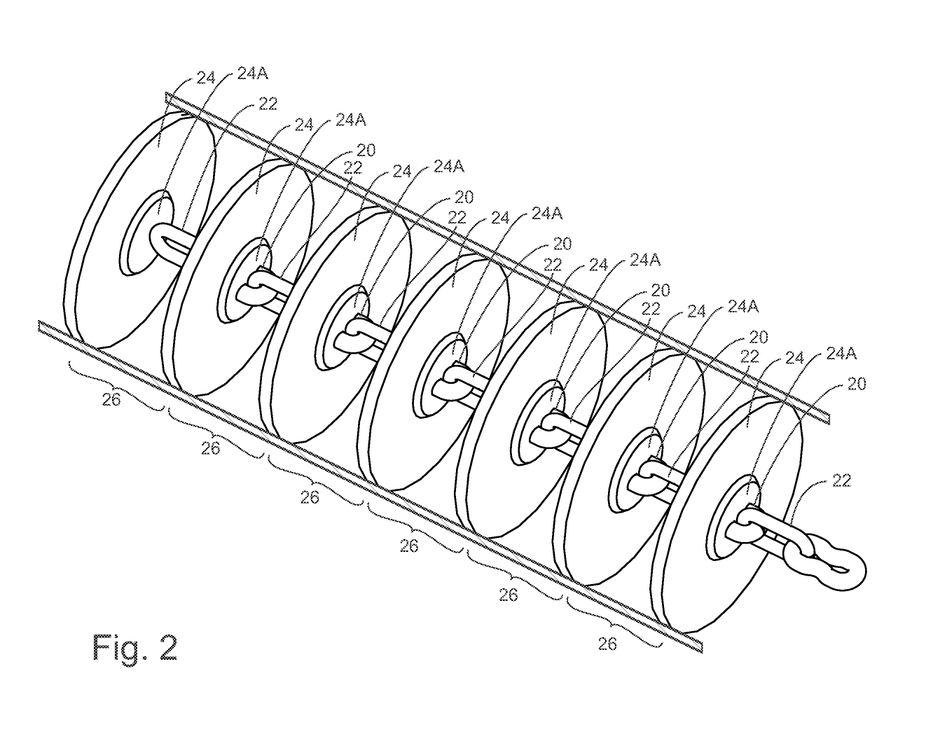

A drive assembly 14 is shown and includes a motor-driven sprocket that engages a conveyor cable chain, described below, contained in the tubular conveyor 12. The opposite end of the conveyor 12 includes a 180 degree turnaround 15. Inlets and discharge outlets, such as at reference numerals 16 and 18, respectively, permit material to be charged into and out of the conveyor as desired. As shown in FIGS. 2-6, the type of chain to which this invention relates is a “cable chain.” A cable chain is formed of interconnected endless rings, wherein the only mechanism for maintaining the interconnection between the rings is the fact that one endless ring extends through an adjacent endless ring. The rings may be circular, oval, flattened oval or other configurations formed by forming wire, rod or bar into an endless loop defining a central void through which an adjacent ring can be passed. Cable chains are therefore functionally distinct from chains formed from bar stock connected together by pins to an intermediate connecting link that pen its a pivot movement around the pins.

As shown in FIGS. 2-6, chain links 20 are interlinked with chain links 22 to form an endless cable chain 20-22. Flights 24 are molded onto chain links 20, and the space between adjacent flights 24 define material-transferring pockets 26 as shown in FIG. 2. As shown, the flights 24 have a circular cross-section and an outer diameter that corresponds closely to the inner diameter of the conveyor 12, permitting the flights 24 to travel along the interior of the conveyor 12 in sliding contact with the inner walls of the conveyor 12, carrying the material through the conveyor 12 in the pockets 26. Each flight 24 has a central, integrally-formed reinforcing hub 24A.

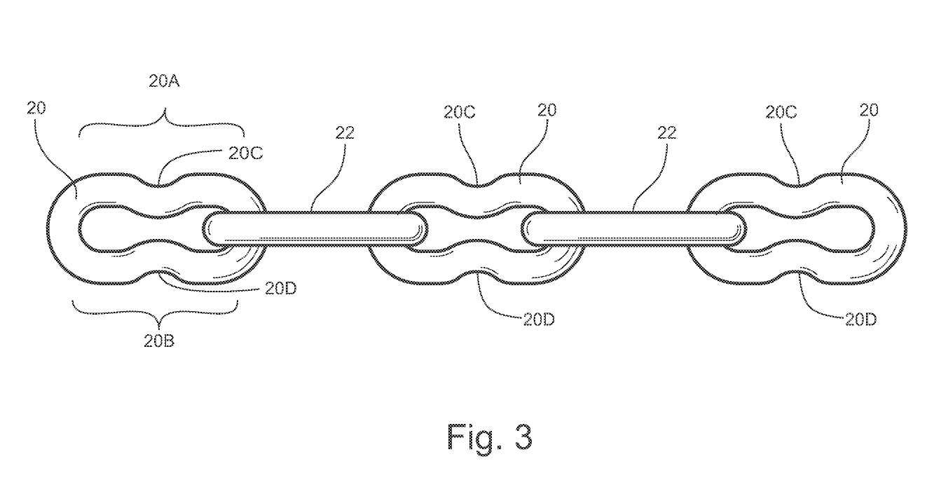

Referring now to FIG. 3, chain link 20 is initially formed as a conventional cable chain link, but is provided with pinched-in first and second opposed, spaced-apart link segments 20A, 20B that include a respective opposing, inwardly extending anchoring recess 20C, 20D on the outer surface. As shown in FIG. 3, the links 22 do not have the recesses 20C, 20D, but if desired all of the links in the conveyor chain 20-22 can be formed of links 22 with the recesses.

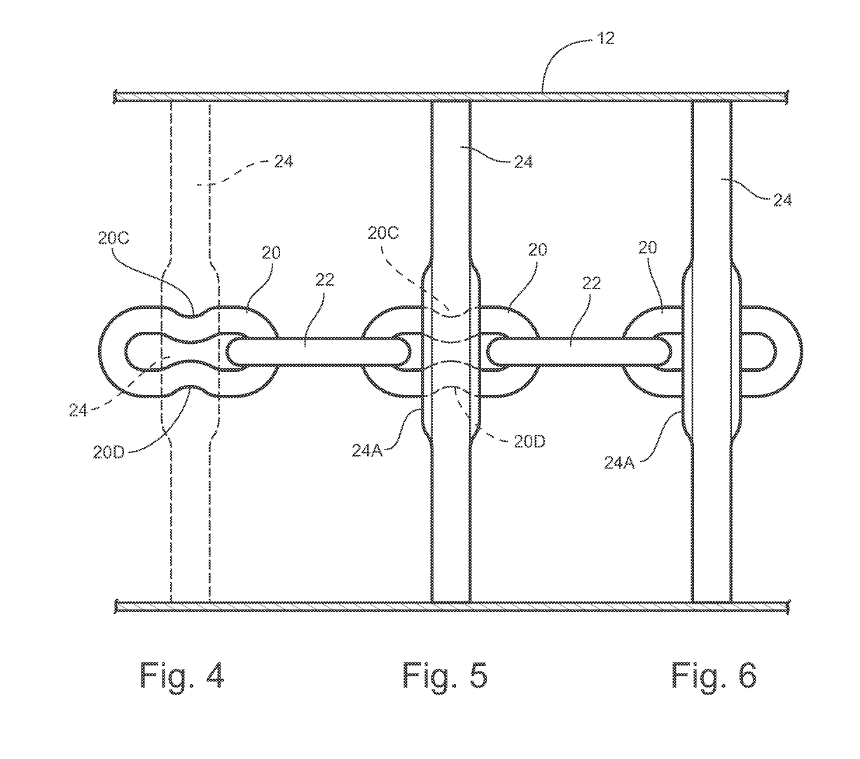

Referring to FIGS. 4, 5 and 6, links 20 are used as a carrier for the flights 24, and in accordance with the invention the flights 24 are molded onto the links 20, using the recesses 20C, 20D as anchors by which the molded flights 24 are retained on the links 20. The flights 24 may be molded of plastic, resin or metal. A suitable plastic is ultra high molecular weight polyethylene because of its reasonable cost, low reactivity with corrosive materials, wear resistance and low coefficient of friction. A suitable resin is Lexan® Polycarbonate (PC) based resin, an amorphous engineering thermoplastic with high mechanical, optical, electrical and thermal properties. A suitable metal is cast iron, which has a low cost and reasonable service life in applications where corrosion, abrasion, chemical resistance and product contamination are not factors.

The geometry of the link 20 is subject to wide variation of design. The chain and the conformation of the interior opening may be any suitable size. The recesses 20C, 20D should be in the range of 15-25 percent of the diameter of the rod stock from which the link is formed.

The link 20 is fabricated by first forming a link in a conventional manner as the length of the conveyor chain 20-22 is formed. The recesses 20C, 20D are formed by pinching the link 20 equidistant opposing ends. It may be suitable to insert a supporting mandrel into the link opening to support the ends of the link 20 as the center portion is pinched. The link 20 is fed into a mold, held in place, and the flight material, for example, ultra high molecular weight polyethylene, is injected into the mold. The plastic material flows into the recesses 20C, 20D, and when hardened forms an integral interference fit with the link to form the link 20. The link 20 is removed from the mold and the next link 20 is fed into the mold. The size of the pockets 26 is determined by the length of each link 20 and 22, and the number of links 22 without flights 24 that are permitted between adjacent flights. If desired, the entire cable chain may be formed of links 20, even though not all links 20 include a flight 24.

The foregoing has described a tubular drag conveyor, conveyor cable chain and cable chain link. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. A cable chain link for a tubular conveyor, comprising an elongate endless loop having first and second opposed, spaced-apart link segments that each include a respective opposing, inwardly extending anchoring recess on an outer surface adapted to receive and retain a conveyor chain flight on the chain link.

2. A cable chain link according to claim 1, wherein the recess defines an annular shape in cross-section.

3. A cable chain link according to claim 1, and having a flight received and retained on the chain link by an interference fit with the recess on the respective outer surface of the link segments.

4. A cable chain link according to claim 3, wherein the flight is molded onto the chain link.

5. A cable chain link according to claim 4, wherein the flight is selected from the group consisting of plastic, resin or metal.

6. A cable chain link according to claim 4, wherein the flight is molded onto the chain link and comprises ultra high molecular weight polyethylene.

7. A cable chain link according to claim 6, wherein the flight includes a centrally-positioned hub having a predetermined thickness and an integrally-formed annular distal flight portion extending radially-outwardly from the hub and having a thickness that is less than the thickness of the hub.

8. A conveyor chain for a tubular conveyor chain, comprising:
(a) a multiplicity of interconnected chain links forming an endless loop for being passed through a conveyor tube, predetermined ones of the chain links comprising an elongate endless loop having first and second opposed, spaced-apart link segments that each include a respective opposing, inwardly extending anchoring recess on their respective outer surface; and
(b) a flight carried on the predetermined ones of the chain links and retained on the chain links by an interference fit with the recess on the respective outer surface of the link segments and defining product-conveying pockets between adjacent ones of the flights.

9. A conveyor chain according to claim 8, wherein the recess defines an annular shape in cross-section.

10. A conveyor chain according to claim 8, and having a flight received and retained on the chain link by an interference fit with the recess on the respective outer surface of the link segments.

11. A conveyor chain according to claim 8, wherein the flight is molded onto the chain link.

12. A conveyor chain according to claim 8, wherein the flight is selected from the group consisting of plastic, resin or metal.

13. A conveyor chain according to claim 12, wherein the flight is molded onto the chain link and comprises ultra high molecular weight polyethylene.

14. A conveyor chain according to claim 8, wherein the flight includes a centrally-positioned hub having a predetermined thickness and an integrally-formed annular distal flight portion extending radially-outwardly from the hub and having a thickness that is less than the thickness of the hub.

15. A conveyor chain according to claim 8, wherein the predetermined ones of the chain links carrying the flights are spaced-apart from each other by chain links not carrying flights, the product carrying pockets being defined by the space between the chain links carrying the flights.

16. A tubular drag conveyor, comprising:
(a) an endless loop conveyor tube having a predetermined cross-sectional shape;
(b) a multiplicity of interconnected chain links positioned coextensively in an endless loop in the conveyor tube, predetermined ones of the chain links comprising an elongate endless loop having first and second opposed, spaced-apart link segments that each include a respective opposing, inwardly extending anchoring recess on an respective outer surface;
(c) a flight carried on the respective predetermined ones of the chain links and retained on the chain links by an interference fit with the recess on the respective outer surface of the link segments and defining product-conveying pockets between adjacent ones of the flights; and
(d) a motor assembly connected to the endless loop of chain links for driving the chain links and the flights carried thereon through the conveyor tube.

17. A tubular drag conveyor according to claim 16, wherein the flights are molded onto the chain links.

18. A tubular drag conveyor according to clam 16, wherein the flights are molded onto the chain links and comprise ultra high molecular weight polyethylene.

19. A tubular drag conveyor according to clam 16, wherein the conveyor tube and the flights are circular in cross-section.

20. A tubular drag conveyor according to clam 16, wherein the predetermined ones of the chain links carrying the flights are spaced-apart from each other by chain links not carrying flights, the product carrying pockets being defined by the space between the chain links carrying the flights.
